(19) United States
(12) Patent Application Publication
(10) Pub. No.: US 2019/0084456 A1
(43) Pub. Date: Mar. 21, 2019

(54) PROTECTIVE SEAT LINER DEVICE AND METHOD

(71) Applicant: Megan Kelly, Nevada City, CA (US)

(72) Inventor: Megan Kelly, Nevada City, CA (US)

(21) Appl. No.: 15/885,699

(22) Filed: Jan. 31, 2018

Related U.S. Application Data
(60) Provisional application No. 62/560,003, filed on Sep. 18, 2017.

(51) Int. Cl. B60N 2/60

(52) U.S. Cl. CPC B60N 2/6027; B60N 2/6036; B60N 2/6054

(57) ABSTRACT

A protective liner includes a form factored waterproof liner, the form factored waterproof liner configured to envelop at least one face of the back seat of a conventional automobile. The protective liner further includes a soft material sized and dimensioned to the disposed across at least one face of the form factored waterproof liner. A fastening mechanism comprising a liner fastener and a material fastener is configured to attach the form factored waterproof liner to the soft material. The protective liner is useful for protecting a back seat of a conventional automobile.

### CROSS-REFERENCE TO RELATED APPLICATION(S)

The present application is related to and claims priority to U.S. Provisional Patent Application No. 62/560,003 filed Sep. 18, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of liners of existing art and more specifically relates to protective liners.

### RELATED ART

Pet owners must deal with the damage that inherently is coupled with owning an animal. Domesticated animals are often subject to shedding their exterior coats, being that of skin, fur or feathers. Animal husbandry involves a myriad of products to prevent property damage. Many of these products are for cleaning up messes left by animals. Conventional cleaning supplies are often used including floor vacuums, mop and buckets and various cleaning solutions. Other products focus on preventative maintenance of their animals or property to prevent costly damage from occurring. Preventative maintenance taken in homes is to cover surfaces that may be susceptible to damage by an animal's claws, spills, or bodily waste.

U.S. Pat. No. 9,221,372 to Arlene Anna Lacey relates to a sanitized protective seat cover kit with disinfecting agent. The described sanitized protective seat cover kit with disinfecting agent includes a protective seat cover kit that is a specially fabricated sanitary and protective seat covering comprising a back section, a seat section, left and right wings, and a pouch containing a sani-pac. The sani-pac contains fumigant particles secured in place by a fine mesh overlaid by an airtight flap. A traveler using the seat cover kit places it over the corresponding parts of a passenger seat to protect the traveler from harmful bacteria or germs that may have been deposited onto the seat by a prior occupant. After use of the protective seat cover, the fumigant particles in the sani-pac, may be exposed to air circulation by the opening of the flap. The protective seat cover is then folded along designated seams and placed completely within the pouch, thus allowing the fumigant particles to sanitize and disinfect the protective seat cover as it is folded within the confines of the pouch.

### SUMMARY OF THE INVENTION

In view of the foregoing disadvantages inherent in the known protective seat liner art, the present disclosure provides a novel protective seat liner. The general purpose of the present disclosure, which will be described subsequently in greater detail, is to provide an efficient and effective protective seat liner.

A protective liner for a back seat of a conventional automobile is disclosed herein. The protective liner includes a form factored waterproof liner; the form factored waterproof liner configured to envelop at least one face of the back seat of a conventional said automobile. The protective liner further includes a soft material sized and dimensioned to the disposed across at least one face of the form factored waterproof liner. A fastening mechanism comprising a liner fastener and a material fastener is configured to attach the form factored waterproof liner to the soft material.

According to another embodiment, a method for installing a protective liner is also disclosed herein. The method for installing a protective liner includes: providing a protective liner for a back seat of a conventional automobile; the conventional automobile having at least one front seat and one back seat, the front seat with a width defined by the perpendicular distance of the material that comprises the seat extending from the right-most side of the automobile to the left-most side of the automobile with respect to a seated passenger, the back seat having at least twice the width of the front seat, the protective liner comprising a form-factored-waterproof liner, the form-factored-waterproof liner configured to envelop at least one face of the back seat of a conventional said automobile, a soft-material, the soft-material sized and dimensioned to be disposed across at least once face of the form-factored-waterproof liner, a fastening-mechanism, (the fastening-mechanism comprising a liner-fastener) and a material-fastener. The fastening-mechanism is configured to attach the form-factored-waterproof liner to the soft-material, aligning the form-factored-waterproof liner to the back-seat. The next step is disposing (installing) the form-factored-waterproof liner across at least one surface of the back-seat, and attaching the soft-material to the form-factored-waterproof liner; aligning the form-factored-waterproof liner to the back-seat; disposing the form-factored-waterproof liner across at least one surface of the back-seat; and attaching the soft-material to the form-factored-waterproof liner.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a protective seat liner, constructed and operative according to the teachings of the present disclosure.

FIG. 1 is a perspective view of the protective liner during an ‘in-use’ condition, according to an embodiment of the disclosure.

FIG. 2 is an exploded view of the protective liner of FIG. 1, according to an embodiment of the present disclosure.

FIG. 3 is a back view of the protective liner of FIG. 1, according to an embodiment of the present disclosure.

FIG. 4 is a perspective view of the protective liner of FIG. 1, according to an embodiment of the present disclosure.

FIG. 5 is a flow diagram illustrating a method of use according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a protective liner and more particularly to a protective seat liner as used to improve the means for and methods of protecting a back seat of a conventional automobile.

Generally, the present invention provides rear vehicle seats with a double-layer protective covering capable of preventing dirt, debris, and other pet-related damages from ruining the back seat. It utilizes a waterproof material, coupled with a softer and more comfortable material to effectively protect the seat while still allowing a pet to maintain comfort while sitting or lying in the seat. It features a fastening mechanism for users to attach and remove the top layer of the cover, enabling vehicle owners to wash the cover. It may include a set of elastic bands, or a draw-string, along the top of the cover in order to firmly secure the cover to the seat and head rest. The present invention offers a simple and convenient method to protecting vehicle seats from pet damages.

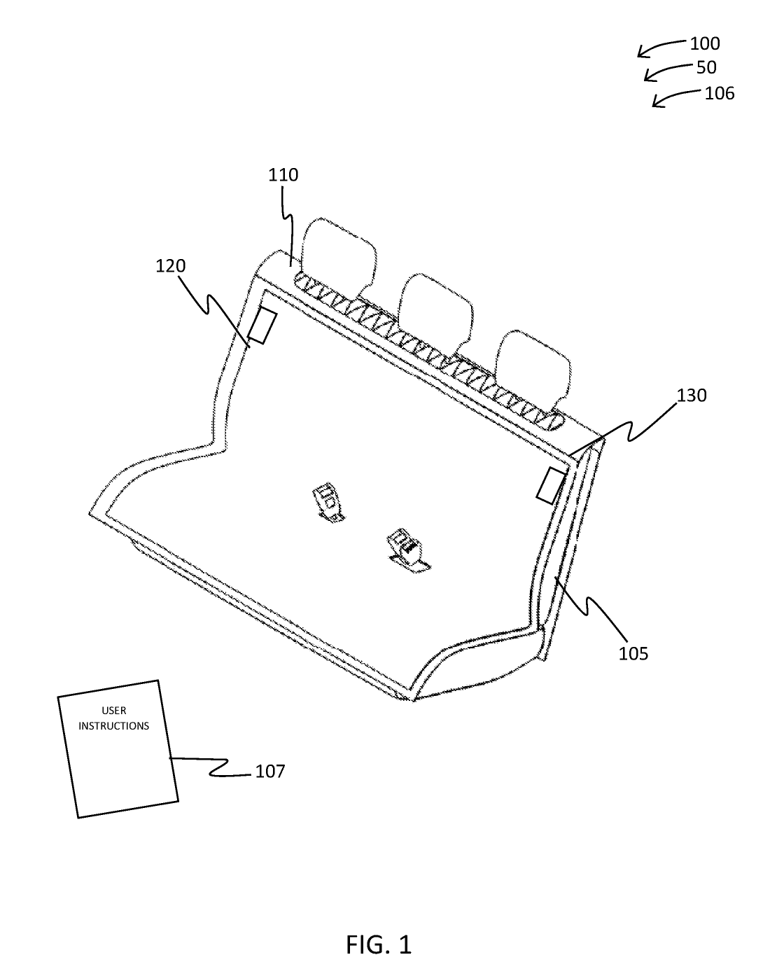

Referring now more specifically to the drawings by numerals of reference, there is shown in FIGS. 1-4, various views of a protective liner 100.

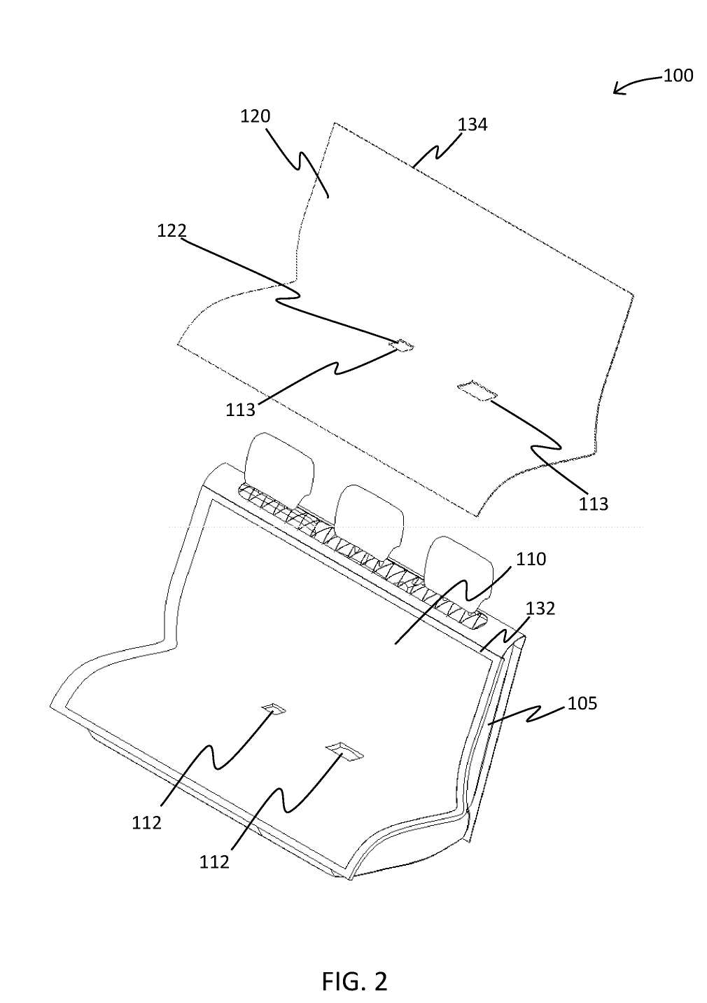

FIG. 1 shows a protective liner 100 during an ‘in-use’ condition 50, according to an embodiment of the present disclosure. Here, the protective liner 100 may be beneficial for use to cover the back seat of an automobile. As illustrated, the protective liner 100 may include a form-factored-waterproof liner 110 configured to envelop at least one face of the back seat 105 of a conventional automobile. A soft-material 120 is sized and dimensioned to the disposed across at least one face of the form-factored-waterproof liner 110. A fastening-mechanism 130, the fastening-mechanism 130 comprising a liner-fastener (FIG. 2) and a material-fastener (FIG. 2), the fastening-mechanism 130 configured to attach the form-factored-waterproof liner 110 to the soft-material 120.

According to one embodiment, the protective liner 100 may be arranged as a kit 106. In particular, the protective liner 100 may further include a set of instructions 107. The instructions 107 may detail functional relationships in relation to the structure of the protective liner 100 such that the protective liner 100 can be used, maintained, or the like, in a preferred manner.

Referring now to FIG. 2 showing the protective liner 100 of FIG. 1, according to an embodiment of the present disclosure. As above, the protective liner 100 may include a form-factored-waterproof liner 110 configured to envelop at least one face of the back seat 105 of a conventional automobile. The form-factored-waterproof liner 110 preferably comprises at least one waterproof material. A soft-material 120 is sized and dimensioned to the disposed across at least one face of the form-factored-waterproof liner 110. The soft-material 120 may comprise of at least one layer. The soft-material 120 may be configured to be machine-washable. A fastening-mechanism 130, the fastening-mechanism 130 comprising a liner-fastener 132 and a material-fastener 134. The fastening-mechanism 130 is configured to attach the form-factored-waterproof liner 110 to the soft-material 120. The fastening-mechanism 130 may comprise a zipping fastener, snaps, a hook-and-loop system or any other conceived fastening mechanisms.

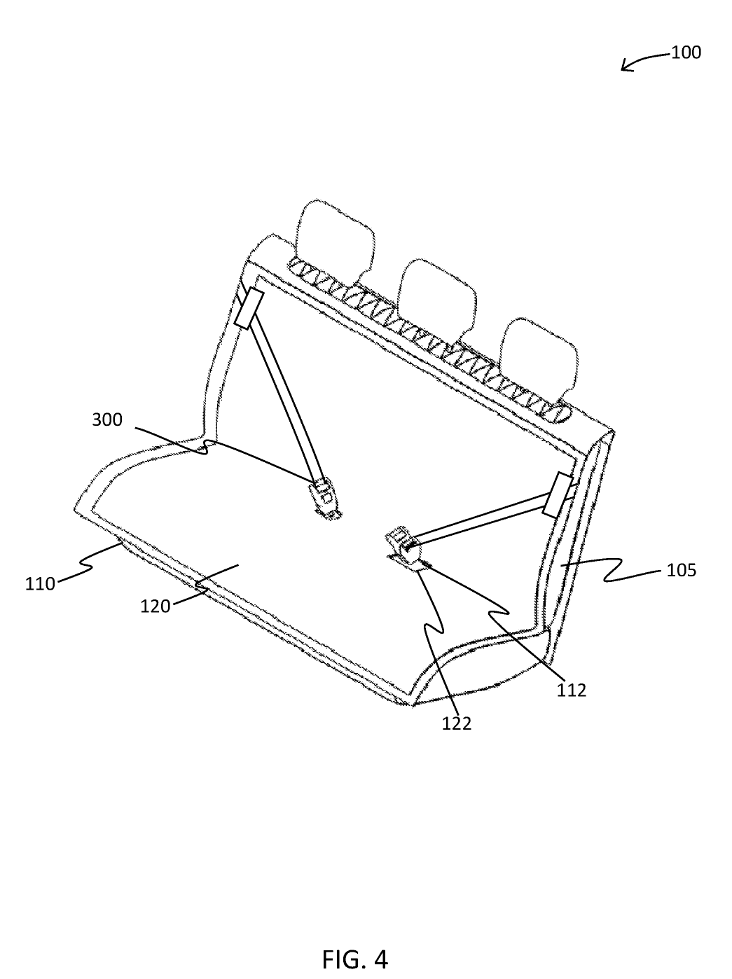

The form-factored-waterproof liner 110 may include first-apertures 112 configured to receive a seat-belt 300 (FIG. 4). The soft-material 120 may include second-apertures 122 configured to receive a seat-belt 300. The first-apertures 112 of the form-factored-waterproof liner 110 and the second-apertures 122 of the soft-material 120 may be configured to align to simultaneously receive a seat-belt 300. The second-apertures 122 may include an aperture-fastening-mechanism 113. The aperture-fastening-mechanism 113 may be configured to close and alternatively open the second-apertures 122 as needed.

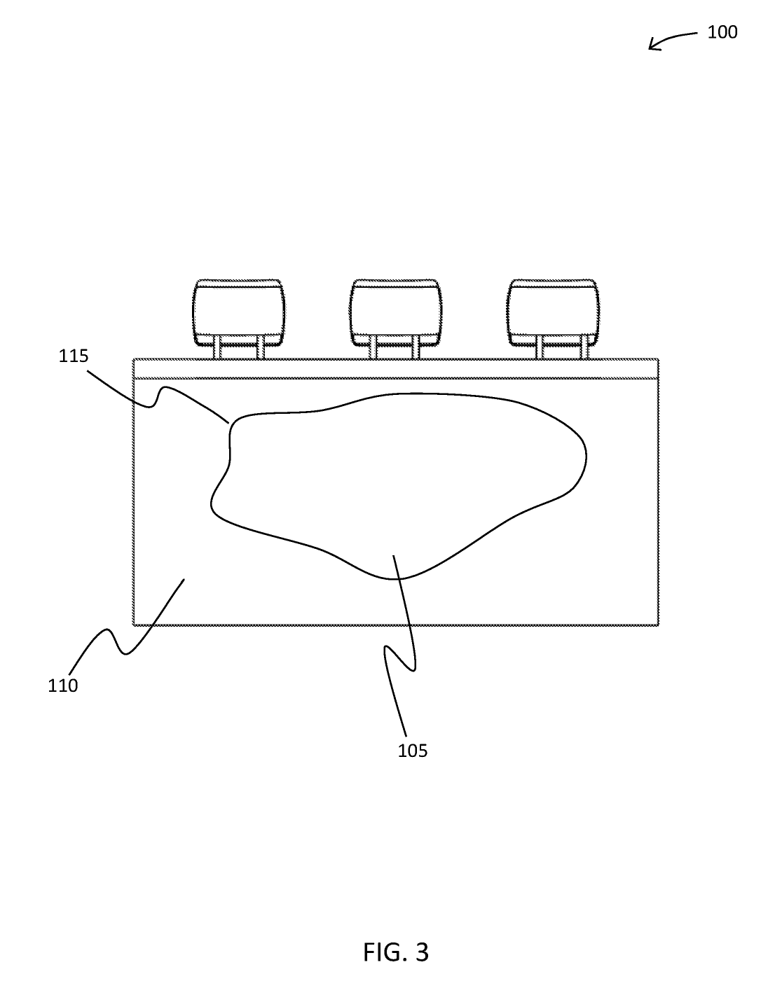

FIG. 3 is a rear view of the protective liner 100 of FIG. 1, according to an embodiment of the present disclosure. As shown, the protective liner 100 is covering a back-seat 105. In this embodiment the form-factored-waterproof liner 110 further includes a retaining-member 115. The retaining-member 115 may be configured to retain the form-factored-waterproof liner 110 on the back-seat 105 in a static position. The retaining-member 115 may comprise a drawstring, and alternatively an elastic-material.

Referring now to FIG. 4, another view of the protective liner 100 of FIG. 1, according to an embodiment of the present disclosure. The protective liner 100 in this embodiment is disposed across a back-seat 105. The soft-material 120 is attached to the form-factored-waterproof liner 110 in the preferred embodiment of the protective liner 100. The first-apertures 112 of the form-factored-waterproof liner 110 and the second-apertures 122 of the soft-material 120 are aligned. As shown, the seat-belt 300 is configured to pass through the first-apertures 112 and the second-apertures 122 of the form-factored-waterproof liner 110 and the soft-material 120.

The form-factored-waterproof liner may include first-apertures 112 configured to receive a seat-belt 300 (FIG. 4). The soft-material may include second-apertures 122 configured to receive a seat-belt 300. The first-apertures 112 of the form-factored-waterproof liner 110 and the second-apertures 122 of the soft-material may be configured to align to simultaneously receive a seat-belt 300. The first-apertures 112 may include an aperture-fastening-mechanism 113. The aperture-fastening-mechanism 113 may be configured to close and alternatively open the first-apertures 112 as needed.

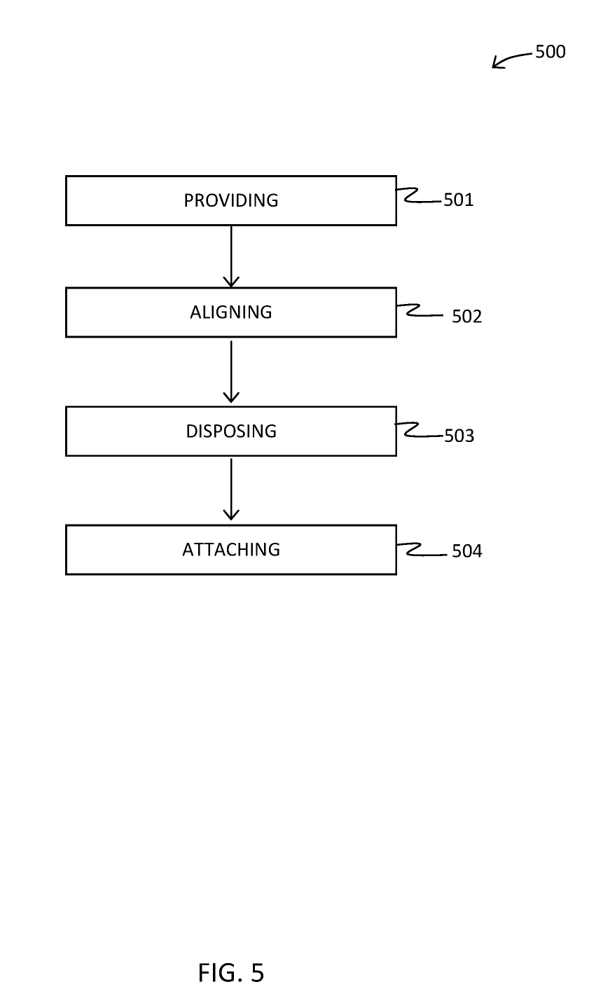

FIG. 5 is a flow diagram illustrating a method for attaching a protective liner to a back seat 500, according to an embodiment of the present disclosure. In particular, the method for attaching a protective liner to a back seat 500 may include one or more components or features of the protective liner 100 as described above. As illustrated, the method for attaching a protective liner to a back seat 500 may include the steps of: step one 501, providing a protective liner for a back seat of a conventional automobile, the conventional automobile having at least one front seat and one back seat, the front seat with a width defined by the perpendicular distance of the material that comprises the seat extending from the right-most side of the automobile to the left-most side of the automobile with respect to a seated passenger, the back seat having at least twice the width of the front seat, the protective liner comprising a form-factored-waterproof liner, the form-factored-waterproof liner configured to envelop at least one face of the back seat of a conventional said automobile; a soft-material, the soft-material sized and dimensioned to be disposed across at least once face of the form-factored-waterproof liner; a fastening-mechanism, the fastening-mechanism comprising a liner-fastener and a material-fastener, the fastening-mechanism configured to attach the form-factored-waterproof liner to the soft-material; step two 502, aligning the form-factored-waterproof liner to the back-seat; step three 503, disposing the form-factored-waterproof liner across at least one surface of the back-seat; step four 504, attaching the soft-material to the form-factored-waterproof liner.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for attaching a protective liner to a back seat, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A protective liner for a back seat of a conventional automobile, the conventional automobile having at least one front seat and one back seat, the front seat with a width defined by the perpendicular distance of the material that comprises the seat extending from the right-most side of the automobile to the left-most side of the automobile with respect to a seated passenger, the back seat having at least twice the width of the front seat, the protective liner comprising:
a form-factored-waterproof liner, the form-factored-waterproof liner configured to envelop at least one face of the back seat of a conventional said automobile;
a soft-material, the soft-material sized and dimensioned to be disposed across at least once face of the form-factored-waterproof liner; and
a fastening-mechanism, the fastening-mechanism comprising a liner-fastener and a material-fastener, the fastening-mechanism configured to attach the form-factored-waterproof liner to the soft-material.

2. The protective liner of claim 1, wherein the form-factored-waterproof liner comprises at least one waterproof-material.

3. The protective liner of claim 1, wherein the form-factored-waterproof liner further includes a retaining-member.

4. The protective liner of claim 3, wherein the retaining-member is a drawstring.

5. The protective liner of claim 3, wherein the retaining-member is an elastic-material.

6. The protective liner of claim 1, wherein the soft-material comprises at least one layer.

7. The protective liner of claim 1, wherein the soft-material is configured to be absorbent.

8. The protective liner of claim 1, wherein the soft-material is configured to be machine-washable.

9. The protective liner of claim 1, wherein the form-factored-waterproof liner includes first-apertures configured to receive a seat-belt.

10. The protective liner of claim 1, wherein the soft-material includes second-apertures configured to align with the first-apertures and configured to receive a seat-belt.

11. The protective liner of claim 1, wherein the fastening-mechanism is a zipping fastener.

12. The protective liner of claim 1, wherein the fastening-mechanism comprises snaps.

13. The protective liner of claim 1, wherein the fastening-mechanism comprises a hook-and-loop system.

14. The protective liner of claim 9, wherein the first-apertures include an aperture-fastening-mechanism.

15. The protective liner of claim 1, wherein the soft-material is configured to be reversible.

16. The protective liner of claim 1, wherein the protective liner is configured to fit to various sizes of said back seat(s).

17. A protective liner, the protective liner comprising:
a protective liner for a back seat of a conventional automobile, the conventional automobile having at least one front seat and one back seat, the front seat with a width defined by the perpendicular distance of the material that comprises the seat extending from the right-most side of the automobile to the left-most side of the automobile with respect to a seated passenger, the back seat having at least twice the width of the front seat, the protective liner comprising:
a form-factored-waterproof liner, the form-factored-waterproof liner configured to envelop at least one face of the back seat of a conventional said automobile;
a soft-material, the soft-material sized and dimensioned to be disposed across at least once face of the form-factored-waterproof liner;
a fastening-mechanism, the fastening-mechanism comprising a liner-fastener and a material-fastener, the fastening-mechanism configured to attach the form-factored-waterproof liner to the soft-material;
wherein the form-factored-waterproof liner comprises at least one waterproof-material;
wherein the form-factored-waterproof liner further includes a retaining-member;
wherein the retaining-member is a drawstring;
wherein the retaining-member is an elastic-material;
wherein the soft-material comprises at least one layer;
wherein the soft-material is configured to be absorbent;
wherein the soft-material is configured to be machine-washable;
wherein the form-factored-waterproof liner includes first-apertures configured to receive a seat-belt;
wherein the soft-material includes second-apertures configured to align with the first-apertures and configured to receive a seat-belt;
wherein the fastening-mechanism is a zipping fastener;
wherein the fastening-mechanism comprises a hook-and-loop system;
wherein the first-apertures include an aperture-fastening-mechanism;
wherein the soft-material is configured to be reversible; and
wherein the protective liner is configured to fit to various sizes of said back seat(s).
